(19) United States
(12) Patent Application Publication
(10) Pub. No.: US 2026/0278579 A1
(43) Pub. Date: Sep. 17, 2026

(54) READING APPARATUS, CHECKOUT SYSTEM, AND READING METHOD

(71) Applicant: NEC Corporation, Tokyo (JP)

(72) Inventors: Takuo DAIKAKU, Tokyo (JP); Masashi SEINO, Tokyo (JP)

(73) Assignee: NEC Corporation, Tokyo (JP)

(21) Appl. No.: 19/163,056

(22) PCT Filed: Mar. 20, 2023
(86) PCT No.: PCT/JP2023/010840

§ 371 Date: Sep. 8, 2025

(51) Int. Cl. G06Q 20/20

(52) U.S. Cl. CPC G06Q 20/208

(57) ABSTRACT

This reading device (10) comprises a commodity reading unit (101), an imaging unit (150), an identification unit (250), and a control unit (230). The commodity reading unit (101) is provided in a passage through which a person who intends to purchase a commodity passes, and reads commodity information from a wireless communication tag attached to the commodity. The imaging unit (150) captures an image including at least one among a reading region of the commodity reading unit (101) and the periphery of the reading region. The identification unit (250) uses the reading result of the commodity reading unit (101) and identifies the commodity carried by the person who has passed through the passage. The control unit (230) controls at least one among the reading condition of the commodity reading unit (101) and the identification unit (250) on the basis of the result obtained by processing the image.

### TECHNICAL FIELD

The present invention relates to a reading apparatus, an information processing apparatus, a checkout system, a reading method, an information processing method, a checkout method, and a medium.

### BACKGROUND ART

For checkout of commodities, for example, a technique for reading information from radio frequency (RF) tags attached to commodities has been developed.

PTL 1 describes a technique of using a result of reading related to a first person who has passed through a gate and a result of reading related to a second person who has passed through the gate next to prevent erroneous recognition of commodities. In the technique described in PTL 1, in a case where both a result of reading of the first person and a result of reading of the second person include information related to an identical tag, the result of the reading of the first person is determined based on an intensity of a radio wave received from the identical tag.

### CITATION LIST

### Patent Literature

PTL 1: WO 2020/179374 A1

### SUMMARY OF INVENTION

### Technical Problem

In the technique of PTL 1 described above, it may take time to wait until the second person finishes passing through the gate to determine the result of the reading of the first person.

In view of the issues described above, an object of the present invention is to provide a reading apparatus, an information processing apparatus, a checkout system, a reading method, an information processing method, a checkout method, and a medium, which make it possible to smoothly identify with high accuracy commodities held by a person who has passed through a predetermined passage.

According to one aspect of the present invention, provided is
a reading apparatus including:
a commodity reading means provided in a passage through which a person who is about to purchase a commodity passes for reading commodity information from a wireless communication tag attached to the commodity;
an imaging means for capturing an image including at least either a reading region of the commodity reading means or a peripheral area of the reading region;
an identification means for identifying, by using results of the reading by the commodity reading means, a commodity held by the person who has passed through the passage; and
a control means for controlling at least either a reading condition of the commodity reading means or the identification means based on a result of processing of the image.

According to another aspect of the present invention, provided is
an information processing apparatus including:
a first acquisition means for acquiring results of reading, the reading being performed by a commodity reading means provided in a passage through which a person who is about to purchase a commodity passes for reading commodity information from a wireless communication tag attached to the commodity;
a second acquisition means for acquiring an image including at least either a reading region of the commodity reading means or a peripheral area of the reading region;
an identification means for identifying, by using the results of the reading by the commodity reading means, a commodity held by the person who has passed through the passage; and
a control means for controlling at least either a reading condition of the commodity reading means or the identification means based on a result of processing of the image.

According to another aspect of the present invention, provided is
a checkout system including:
the reading apparatus described above; and
a checkout apparatus that performs checkout processing of a target commodity identified by the identification means as the commodity held by the person who has passed through the passage.

According to another aspect of the present invention, provided is
a reading method including:
reading, with a commodity reading means provided in a passage through which a person who is about to purchase a commodity passes, commodity information from a wireless communication tag attached to the commodity;
capturing an image including at least either a reading region of the commodity reading means or a peripheral area of the reading region;
identifying, by using results of the reading by the commodity reading means, a commodity held by the person who has passed through the passage; and
controlling at least either a reading condition of the commodity reading means or an identification method of the commodity held by the person who has passed through the passage based on a result of processing of the image.

According to another aspect of the present invention, provided is
an information processing method including causing one or more computers to:
acquire results of reading, the reading being performed by a commodity reading means provided in a passage through which a person who is about to purchase a commodity passes for reading commodity information from a wireless communication tag attached to the commodity;
acquire an image including at least either a reading region of the commodity reading means or a peripheral area of the reading region;
identify, by using the results of the reading by the commodity reading means, a commodity held by the person who has passed through the passage; and
control at least either a reading condition of the commodity reading means or an identification method of the commodity held by the person who has passed through the passage based on a result of processing of the image.

According to another aspect of the present invention, provided is
a checkout method including causing one or more computers to perform checkout processing of a target commodity identified by the identification means included in the reading apparatus described above as the commodity held by the person who has passed through the passage.

According to another aspect of the present invention, provided is
a computer-readable medium on which a program is stored, the program causing a computer to function as:
a first acquisition means for acquiring results of reading, the reading being performed by a commodity reading means provided in a passage through which a person who is about to purchase a commodity passes for reading commodity information from a wireless communication tag attached to the commodity;
a second acquisition means for acquiring an image including at least either a reading region of the commodity reading means or a peripheral area of the reading region;
an identification means for identifying, by using the results of the reading by the commodity reading means, a commodity held by the person who has passed through the passage; and
a control means for controlling at least either a reading condition of the commodity reading means or the identification means based on a result of processing of the image.

### ADVANTAGEOUS EFFECTS OF INVENTION

According to one aspects of the present invention, it is possible to provide a reading apparatus, an information processing apparatus, a checkout system, a reading method, an information processing method, a checkout method, and a medium, which make it possible to smoothly identify with high accuracy commodities held by a person who has passed through a predetermined passage.

### BRIEF DESCRIPTION OF DRAWINGS

FIG. 1 It is a diagram illustrating an outline of a reading device according to a first example embodiment.

FIG. 2 It is a diagram illustrating an outline of an information processing device according to the first example embodiment.

FIG. 3 It is a diagram exemplifying a functional configuration of the reading device according to the first example embodiment.

FIG. 4 It is a diagram exemplifying a use environment of the reading device according to the first example embodiment.

FIG. 5 It is a diagram exemplifying the use environment of the reading device according to the first example embodiment.

FIG. 6 It is a diagram illustrating an outline of a reading method according to the first example embodiment.

FIG. 7 It is a diagram exemplifying a computer for achieving an information processing device.

FIG. 8 It is a diagram illustrating an outline of an information processing method according to the first example embodiment.

FIG. 9 It is a diagram exemplifying a functional configuration of a reading device according to a second example embodiment.

FIG. 10 It is a diagram illustrating an outline of a checkout system according to a third example embodiment.

FIG. 11 It is a diagram exemplifying a functional configuration of a checkout device according to the third example embodiment.

FIG. 12 It is a diagram exemplifying a use environment of a reading device according to the third example embodiment.

### EXAMPLE EMBODIMENT

Hereinafter, example embodiments of the present invention will be described with reference to the drawings. In all the drawings, the same components are denoted by the same reference numerals, and the description thereof will be omitted as appropriate.

### First Example Embodiment

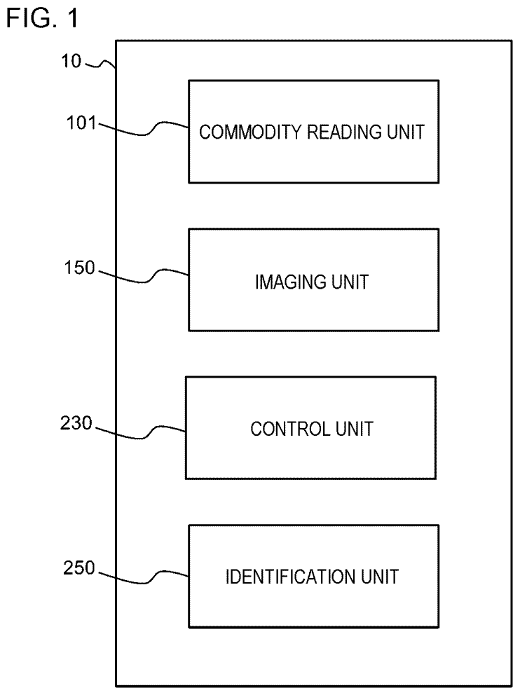

FIG. 1 is a diagram illustrating an outline of a reading device 10 according to a first example embodiment. The reading device 10 according to the present example embodiment includes a commodity reading unit 101, an imaging unit 150, an identification unit 250, and a control unit 230. The commodity reading unit 101 is provided in a passage through which a person who is about to purchase a commodity passes, and reads commodity information from a wireless communication tag attached to the commodity. The imaging unit 150 captures an image including at least either reading regions of the commodity reading unit 101 or a peripheral area of the reading regions. The identification unit 250 identifies, by using results of the reading by the commodity reading unit 101, a commodity held by the person who has passed through the passage. The control unit 230 controls at least either a reading condition of the commodity reading unit 101 or the identification unit 250 based on a result of processing of the image.

With the reading device 10, it is possible to smoothly identify with high accuracy commodities held by a person who has passed through the predetermined passage.

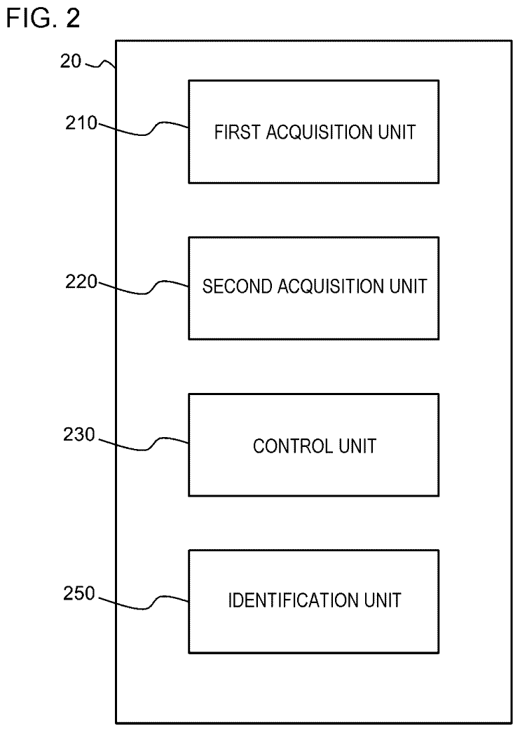

FIG. 2 is a diagram illustrating an outline of an information processing device 20 according to the present example embodiment. The information processing device 20 according to the present example embodiment includes a first acquisition unit 210, a second acquisition unit 220, the identification unit 250, and the control unit 230. The first acquisition unit 210 acquires a result of reading, the reading being performed by the commodity reading unit 101. The commodity reading unit 101 is provided in a passage through which a person who is about to purchase a commodity passes, and reads commodity information from a wireless communication tag attached to the commodity. The second acquisition unit 220 acquires an image including at least either the reading regions of the commodity reading unit 101 or the peripheral area of the reading regions. The identification unit 250 identifies, by using results of the reading by the commodity reading unit 101, a commodity held by the person who has passed through the passage. The control unit 230 controls at least either a reading condition of the commodity reading unit 101 or the identification unit 250 based on a result of processing of the image.

With the information processing device 20, it is possible to smoothly identify with high accuracy commodities held by a person who has passed through the predetermined passage.

Hereinafter, detailed examples of the reading device 10 and the information processing device 20 will be described.

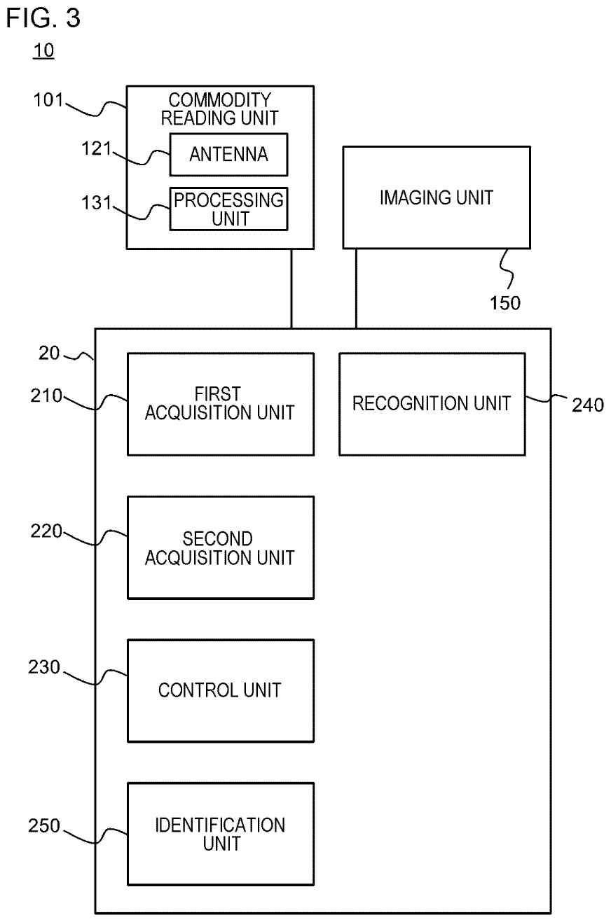

FIG. 3 is a diagram exemplifying a functional configuration of the reading device 10 according to the present example embodiment. In the example of FIG. 3, the reading device 10 includes the commodity reading unit 101, the imaging unit 150, and the information processing device 20. The information processing device 20 includes the first acquisition unit 210, the second acquisition unit 220, the control unit 230, the identification unit 250, and a recognition unit 240.

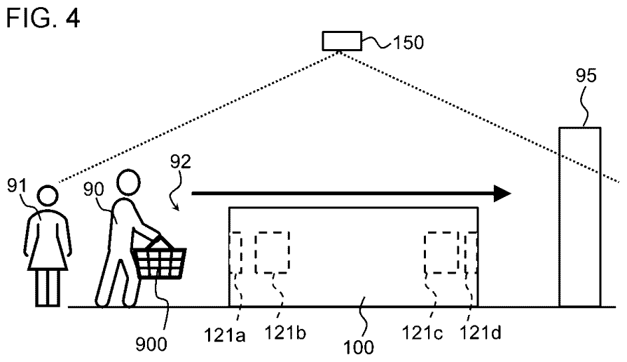

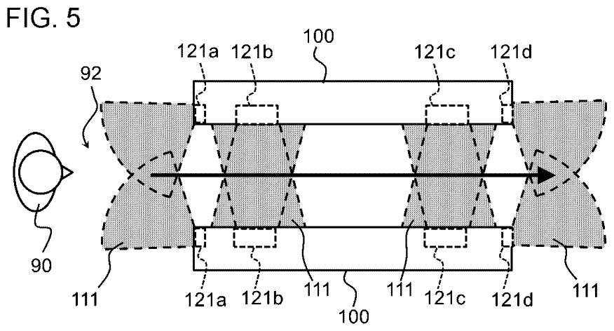

FIGS. 4 and 5 are diagrams exemplifying a use environment of the reading device 10 according to the present example embodiment. FIG. 4 illustrates a state in which a passage 92 through which a person 90 who is about to purchase commodities passes is viewed from one side. FIG. 5 illustrates a state in which the passage 92 through which the person 90 who is about to purchase the commodity passes is viewed from above. In the examples of FIGS. 4 and 5, the person 90 passes through the passage 92 along an arrow.

In a shop that sells commodities, a wireless communication tag that stores commodity information of a commodity is attached to the commodity. The commodity information includes, for example, identification information for identifying the commodity. The wireless communication tag is, for example, a radio frequency identification (RFID) tag.

The person 90 passes through the predetermined passage 92 while holding commodities desired to be purchased. In the present example embodiment, the passage 92 is defined with reference to at least one of housings 100. Specifically, the passage 92 is at least partially or wholly sandwiched between the two housings 100. However, it is not necessary to always provide the two housings 100. For example, the passage 92 is defined along at least one of the housings 100. The housings 100 may form a walk-through gate. The housings 100 are provided, for example, near an exit of a shop that sells commodities.

The housings 100 are provided with the commodity reading unit 101. The commodity reading unit 101 includes antennas 121 for communicating with wireless communication tags.

The commodity reading unit 101 includes a processing unit 131 that drives the antennas 121 and processes signals received via the antennas 121. The commodity reading unit 101 communicates with wireless communication tags positioned in each of reading regions 111, making it possible to read commodity information stored in the wireless communication tags. The commodity reading unit 101 outputs the read commodity information to the first acquisition unit 210 of the information processing device 20 as a result of the reading.

The reading regions 111 of the commodity reading unit 101 are defined based on the housings 100. When viewed from above, the reading regions 111 of the commodity reading unit 101 may be partially or wholly sandwiched between the two housings 100. When viewed from above, the reading regions 111 of the commodity reading unit 101 may not be partially or wholly sandwiched between the two housings 100.

In the examples of FIGS. 4 and 5, the commodity reading unit 101 includes a plurality of the antennas 121. One or more of the antennas 121 of the commodity reading unit 101 is or are provided on a side wall or side walls, which faces or face the passage 92, of one or both of the housings 100. Antennas 121a, antennas 121b, antennas 121c, and antennas 121d are respectively provided as the antennas 121 to the two housings 100.

The antennas 121b and the antennas 121c are provided on side surfaces, which face the passage 92, of the housings 100. One of the antennas 121b, which is provided to one of the housings 100, and another one of the antennas 121b, which is provided to another one of the housings 100, face each other across the passage 92. One of the antennas 121c, which is provided to the one of the housings 100, and another one of the antennas 121c, which is provided to the other one of the housings 100, face each other across the passage 92. When viewed from above, the reading regions 111 of the antennas 121b and the antennas 121c are wholly sandwiched between the two housings 100.

The antennas 121a are provided on side surfaces, which are near an entrance side of the passage 92, of the housings 100. The antennas 121d are provided on side surfaces, which are near an exit side of the passage 92, of the housings 100. When viewed from above, the reading regions 111 of the antennas 121a and the antennas 121d are not sandwiched between the two housings 100.

The commodity reading unit 101 is able to output commodity information read by at least one of the plurality of antennas 121 as a result of the reading of the commodity reading unit 101. The commodity reading unit 101 may otherwise output commodity information at least temporarily read by all of the plurality of antennas 121 as reading information of the commodity reading unit 101.

The reading condition of the commodity reading unit 101 may be controlled by the control unit 230. The reading condition of the commodity reading unit 101 is, for example, at least one of an output intensity of a radio wave from the commodity reading unit 101, an output direction of the radio wave from the commodity reading unit 101, and a reading threshold for a reception intensity of the commodity reading unit 101.

In a case where the commodity reading unit 101 includes the plurality of antennas 121, the commodity reading unit 101 is able to simultaneously increase or simultaneously decrease the output intensity of all the antennas 121. The output intensity of a radio wave from each of the antennas 121 may be independently controlled. The output direction of a radio wave from the commodity reading unit 101 may be controlled, for example, by changing a direction of at least one of the antennas 121 with an actuator.

For example, increasing the output intensities of radio waves from some of the antennas 121, among the plurality of antennas 121, makes it possible to increase the output intensity of a radio wave in a certain direction. Directing at least one of the antennas 121 in a certain direction otherwise makes it possible to increase the output intensity of a radio wave in the For example, lowering the output intensities of radio waves from some of the antennas 121, among the plurality of antennas 121, makes it possible to lower the output intensity of a radio wave in a certain direction. Directing at least one of the antennas 121 in a direction other than a certain direction otherwise makes it possible to lower the output intensity of a radio wave in the certain direction.

The reading threshold for the reception intensity of the commodity reading unit 101 is, for example, a threshold related to whether received information is recognized as commodity information. For example, in a case where the reception intensity of a radio wave from a wireless communication tag is equal to or higher than the reading threshold, the processing unit 131 reads commodity information acquired by receiving the radio wave. On the other hand, in a case where the reception intensity of a radio wave from a wireless communication tag is lower than the reading threshold, the processing unit 131 does not read commodity information acquired by receiving the radio wave.

The processing unit 131 of the commodity reading unit 101 controls one or more of the antennas 121 based on a control signal from the control unit 230 of the information processing device 20. The control performed by the control unit 230 will be described later in detail.

The first acquisition unit 210 of the information processing device 20 acquires, from the commodity reading unit 101, a result of reading of the commodity reading unit 101, which is acquired at a timing at which the person 90 passes through the passage 92. Based on the result of the reading, which is acquired by the first acquisition unit 210, the identification unit 250 then identifies commodities (hereinafter also referred to as “target commodities”) held by the person 90 who has passed through passage 92. For example, the identification unit 250 identifies one or more pieces of commodity information included in the result of the reading, which is acquired by the first acquisition unit 210, as commodity information of the commodities held by the person 90 who has passed through the passage 92.

The identification unit 250 outputs the commodity information of the target commodities. The identification unit 250 may output the commodity information of the target commodities to another device, or may store the commodity information in a storage unit (not illustrated) that is accessible from the identification unit 250. It is possible to use the commodity information of the target commodities for checkout processing, for example.

The imaging unit 150 captures an image including at least either the reading regions 111 of the commodity reading unit 101 or the peripheral area of the reading regions 111. The imaging unit 150 is, for example, a camera. The imaging unit 150 is provided at a ceiling of a shop, for example. The second acquisition unit 220 of the information processing device 20 acquires the image captured by the imaging unit 150 from the imaging unit 150. The image acquired by the second acquisition unit 220 may be frame images forming a moving image.

That is, the imaging unit 150 may capture a moving image, and the second acquisition unit 220 may acquire the moving image.

The recognition unit 240 recognizes, by processing the image, a state of at least either a peripheral area of the passage 92 or an interior of the passage 92. The recognition unit 240 is able to perform state recognition by processing an image using an existing technique. For example, the recognition unit 240 may recognize the state of at least either the peripheral area of the passage 92 or the interior of the passage 92 using a learning model having undergone machine learning.

The recognition unit 240 recognizes, by, for example, analyzing the image acquired by the imaging unit 150, the person 90 passing through the passage 92. That is, the recognition unit 240 is able to detect the person 90 passing through the passage 92. Based on a result of the recognition (a result of the detection) of the recognition unit 240, the control unit 230 then causes the commodity reading unit 101 to read commodity information from wireless communication tags. That is, while the person 90 passing through the passage 92 is detected, the control unit 230 causes the commodity reading unit 101 to read the commodity information from the wireless communication tags. The control unit 230 may cause the commodity reading unit 101 to read commodity information from wireless communication tags based on a result of detection of a human detection sensor (not illustrated), instead of a result of recognition of the recognition unit 240. In that case, the human detection sensor is installed to be able to detect the person 90 positioned in the passage 92.

The control unit 230 controls at least either the reading condition of the commodity reading unit 101 or the identification unit 250 based on the result of the recognition of the recognition unit 240.

In the present example embodiment, an example in which the recognition unit 240 recognizes, by processing an image, the state of the peripheral area of the passage 92 will be described. In the present example embodiment, an example in which the control unit 230 controls the reading condition of the commodity reading unit 101 based on a result of the recognition of the recognition unit 240 will be described.

In the present example embodiment, the control unit 230 is able to control the reading condition of the commodity reading unit 101 based on a result of recognition for an image captured at a timing at which the person 90 is present in the passage 92. The control unit 230 may control the reading condition of the commodity reading unit 101 based on a result of recognition for an image captured at a timing at which no person 90 is present in the passage 92.

For example, the recognition unit 240 detects, by processing an image acquired by the imaging unit 150, at least either a store fixture 95 positioned in the peripheral area of the passage 92 or a person 91 who is not passing through the passage 92.

Hereinafter, a first example and a second example of a method in which the control unit 230 controls the reading condition of the commodity reading unit 101 will be described.

### First Example of Control

The recognition unit 240 identifies, by processing an image, the position of the store fixture 95 positioned in the peripheral area of the passage 92. The control unit 230 lowers the output intensity of a radio wave from the commodity reading unit 101 at least in a direction in which the store fixture 95 is present.

A plurality of commodities are displayed on the store fixture 95. Since such commodities are not commodities that the person 90 is about to purchase, the commodities may not be read by the commodity reading unit 101. Therefore, the control unit 230 controls the commodity reading unit 101 to lower the output intensity of a radio wave from the commodity reading unit 101 in the direction in which the store fixture 95 is present. The control unit 230 may control the commodity reading unit 101 to prevent a radio wave from being outputted from the commodity reading unit 101 in the direction in which the store fixture 95 is present. In that case, the commodity reading unit 101 outputs radio waves only in other directions to perform reading.

For example, in the example of FIG. 4, the store fixture 95 is present near the exit of the passage 92. An image captured by the imaging unit 150 includes the store fixture 95. The recognition unit 240 then recognizes that the store fixture 95 is present and its position in the image. The recognition unit 240 outputs information indicating the position of the store fixture 95. In a storage unit that is accessible from the recognition unit 240, positional relationship information indicating a relationship between a position in an image and a position in an actual shop (for example, a position based on the housings 100) is held in advance. The recognition unit 240 is then able to convert, by using the positional relationship information, information indicating the position in the image into information indicating the position in the shop and output the converted information.

As the information indicating the position of the store fixture 95 is acquired from the recognition unit 240, the control unit 230 controls an output of a radio wave from the commodity reading unit 101 based on the information indicating the position of the store fixture 95. Specifically, at a timing at which the commodity reading unit 101 performs reading, the control unit 230 sets the output intensity of a radio wave in the direction in which the store fixture 95 is present lower than the output intensity of a radio wave in another direction. In the examples of FIGS. 4 and 5, for example, the control unit 230 sets the output intensity of a radio wave from each of the antennas 121d that output the radio waves toward the store fixture 95 lower than the output intensity of a radio wave from the other antennas 121. As a result, the pieces of commodity information of the commodities displayed on the store fixture 95 become difficult to be read.

In a case where the store fixture 95 is present in the peripheral area of the passage 92, it can be said that there is an environment that may easily include commodity information serving as noise to a result of reading. Therefore, the control unit 230 may lower outputs of radio waves in all directions or may increase the reading threshold described above.

### Second Example of Control

The recognition unit 240 detects, by processing an image, the person 91 who is not passing through the passage 92. In a case where the person 91 who is not passing through the passage 92 is detected, the control unit 230 lowers the output intensity of a radio wave from the commodity reading unit 101 at least in a direction in which the person 91 who is not passing through the passage 92 is present.

The person 91 may be, for example, a person who is about to next pass through the passage 92. The person 91 may otherwise be a person who is about to pass near the passage 92. Such a person 91 may also holds commodities. Since such commodities that the person 91 holds are not commodities that the person 90 is about to purchase, the commodities may not be read by the commodity reading unit 101. Therefore, the control unit 230 controls the commodity reading unit 101 to lower the output intensity of a radio wave from the commodity reading unit 101 in the direction in which the person 91 is present. The control unit 230 may control the commodity reading unit 101 to prevent a radio wave from being outputted from the commodity reading unit 101 in the direction in which the person 91 is present. In that case, the commodity reading unit 101 outputs radio waves only in other directions to perform reading.

For example, in the example of FIG. 4, the person 91 is present near the entrance of the passage 92. An image captured by the imaging unit 150 includes the person 91. The recognition unit 240 then recognizes that the person 91 is present and its position in the image. It is possible to identify whether the person 91 is not passing through the passage 92 or is not about to pass through the passage 92 based on, for example, the position, a posture, a direction of the face, and a moving situation, for example, of the person 91.

The recognition unit 240 outputs information indicating the position of the person 91. Similar to the first example, the recognition unit 240 is then able to convert, by using the positional relationship information, information indicating the position in the image into information indicating the position in the shop and output the converted information.

As the information indicating the position of the person 91 is acquired from the recognition unit 240, the control unit 230 controls an output of a radio wave of the commodity reading unit 101 based on the information indicating the position of the person 91. Specifically, in a case where the commodity reading unit 101 performs reading, the control unit 230 sets the output intensity of a radio wave in the direction in which the person 91 is present lower than the output intensity of a radio wave in another direction. In the examples of FIGS. 4 and 5, for example, the control unit 230 sets the output intensity of a radio wave from each of the antennas 121a that output the radio waves toward the person 91 lower than the output intensity from the other antennas 121. As a result, commodity information of commodities held by the person 91 becomes difficult to be read.

In a case where the person 91 is present in the peripheral area of the passage 92, it can be said that there is an environment that may easily include commodity information serving as noise to a result of reading. Therefore, the control unit 230 may lower outputs of radio waves in all directions or may increase the reading threshold described above.

The first example and the second example of the method in which the control unit 230 controls the reading condition of the commodity reading unit 101 have been described above. However, the method in which the control unit 230 controls the reading condition of the commodity reading unit 101 is not limited to these examples.

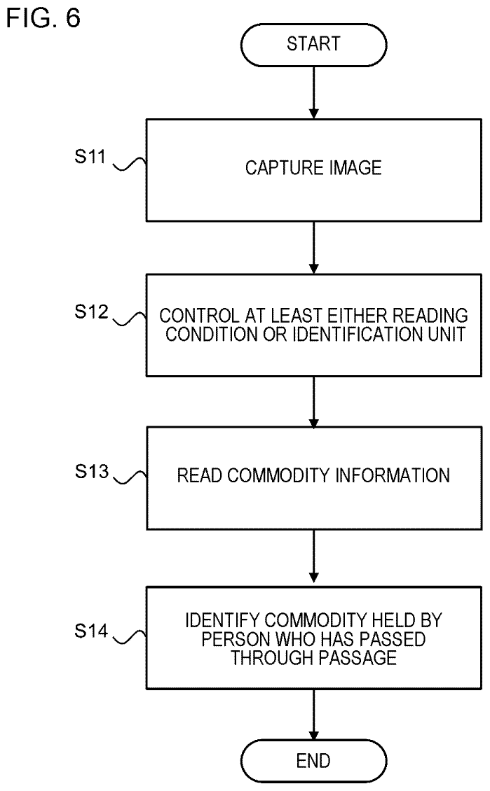

FIG. 6 is a diagram illustrating an outline of a reading method according to the present example embodiment. The reading method according to the present example embodiment includes steps S11, S12, S13, and S14. Step S13 is a step at which the commodity reading unit 101 provided in the passage 92 through which the person 90 who is about to purchase a commodity passes reads commodity information from a wireless communication tag attached to the commodity. Step S11 is a step at which an image including at least either the reading regions 111 of the commodity reading unit 101 or the peripheral area of the reading regions 111 is to be captured. Step S14 is a step at which, by using results of the reading by the commodity reading unit 101, a commodity held by the person 90 who has passed through the passage 92 are identified. Step S12 is a step at which at least either the reading condition of the commodity reading unit 101 or an identification method of the commodity held by the person 90 who has passed through the passage 92 is to be controlled based on a result of processing of the image.

A hardware configuration of the information processing device 20 will be described below. Each of functional components (the first acquisition unit 210, the second acquisition unit 220, the control unit 230, the recognition unit 240, and the identification unit 250) of the information processing device 20 may be achieved by hardware (for example, a hard-wired electronic circuit or the like) that achieves each of the functional components, or may be achieved by a combination of hardware and software (for example, a combination of an electronic circuit and a program that controls the electronic circuit or the like). Hereinafter, a case where the functional components of the information processing device 20 are achieved by a combination of hardware and software will be further described.

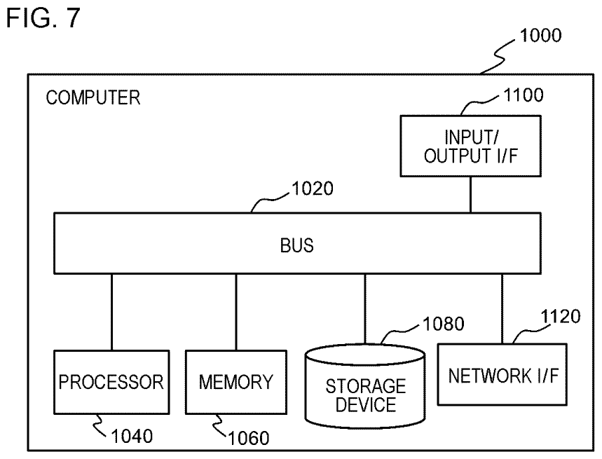

FIG. 7 is a diagram exemplifying a computer 1000 for achieving the information processing device 20. The computer 1000 is a desired computer. For example, the computer 1000 is a system on chip (SoC), a personal computer (PC), a server machine, a tablet terminal, or a smartphone, for example. The computer 1000 may be a dedicated computer designed to achieve the information processing device 20, or may be a general-purpose computer. The information processing device 20 may be achieved by one computer 1000 or may be achieved by a combination of a plurality of computers 1000.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection. The processor 1040 is any of processors such as a central processing unit (CPU), a graphics processing unit (GPU), or a field-programmable gate array (FPGA). The memory 1060 is a primary storage device achieved by using a random access memory (RAM) or the like. The storage device 1080 is a secondary storage device achieved by using a hard disk, a solid state drive (SSD), a memory card, read only memory (ROM), or the like.

The input/output interface 1100 is an interface connecting the computer 1000 and an input/output device. For example, an input device such as a keyboard and an output device such as a display are connected to the input/output interface 1100. A method of connecting the input/output interface 1100 to the input device or the output device may be a wireless connection or a wired connection.

The network interface 1120 is an interface for connecting the computer 1000 to a network. This communication network is, for example, a local area network (LAN) or a wide area network (WAN). A method of connecting the network interface 1120 to the network may be a wireless connection or a wired connection.

The information processing device 20 is communicable with the commodity reading unit 101 and the imaging unit 150 via the input/output interface 1100 or the network interface 1120.

The storage device 1080 stores program modules that achieve the functional components of the information processing device 20. The processor 1040 reads and executes the program modules into the memory 1060, thereby achieving functions related to the program A hardware configuration of the processing unit 131 will be described below. The processing unit 131 of the commodity reading unit 101 may be achieved by hardware (for example, a hard-wired electronic circuit or the like) that achieves the processing unit 131, or may be achieved by a combination of hardware and software (for example, a combination of an electronic circuit and a program that controls the electronic circuit or the like).

A hardware configuration of a computer that achieves the processing unit 131 is represented as illustrated in FIG. 7, for example, similar to the information processing device 20. However, the storage device 1080 of the computer 1000 that achieves the processing unit 131 stores program modules that achieve functions of the processing unit 131. The processing unit 131 is communicable with the information processing device 20 via the input/output interface 1100 or the network interface 1120 of the computer 1000 that achieves the processing unit 131.

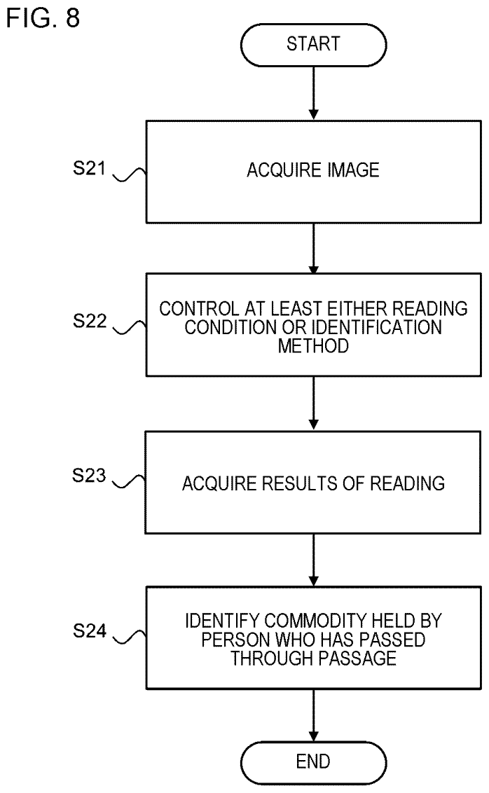

FIG. 8 is a diagram illustrating an outline of an information processing method according to the present example embodiment. The information processing method according to the present example embodiment includes steps S21, S22, S23, and S24. At step S23, one or more computers acquire a result of reading, the reading being performed by the commodity reading unit 101. The commodity reading unit 101 is provided in the passage 92 through which the person 90 who is about to purchase a commodity passes, and reads commodity information from a wireless communication tag attached to the commodity. Step S21 is a step at which the one or more computers acquire an image including at least either the reading regions 111 of the commodity reading unit 101 or the peripheral area of the reading regions 111. Step S24 is a step at which the one or more computers identify, by using results of the reading by the commodity reading unit 101, a commodity held by the person 90 who has passed through the passage 92. At step S22, the one or more computers control at least either the reading condition of the commodity reading unit 101 or an identification method of the commodity held by the person 90 who has passed through the passage 92 based on a result of processing of the image.

According to the present example embodiment, as described above, the control unit 230 controls at least either the reading condition of the commodity reading unit 101 or the identification unit 250 based on a result of processing of an image. Therefore, it is possible to smoothly identify with high accuracy commodities held by the person 90 who has passed through the predetermined passage 92.

### Modification

The reading device 10 according to the present modification is identical to the reading device 10 according to the first example embodiment except for those points described below.

In the present modification, an example in which the recognition unit 240 recognizes, by processing an image, the state of the interior of the passage 92 will be described. In the present example embodiment, an example in which the control unit 230 controls the reading condition of the commodity reading unit 101 based on a result of the recognition of the recognition unit 240 will be described.

In the present example embodiment, the control unit 230 may control the reading condition of the commodity reading unit 101 based on a result of recognition for an image captured at a timing at which the person 90 is present in the passage 92. In particular, the control unit 230 may control the reading condition of the commodity reading unit 101 based on a result of recognition for an image captured at a timing at which the person 90 is present near the entrance of the passage 92.

Processing of the recognition unit 240 and the control unit 230 exemplified below may be solely performed, or may be performed together with the processing described in the first example embodiment. That is, as described in the first example embodiment, the control unit 230 according to the present example embodiment may not only control the reading condition by using a result of recognition of the state in the peripheral area of the passage 92, but also further control the reading condition by using a result of recognition of the state of the interior of the passage 92.

Hereinafter, a third example and a fourth example of the method in which the control unit 230 controls the reading condition of the commodity reading unit 101 will be described.

### Third Example of Control

The recognition unit 240 estimates, by processing an image, a quantity of commodities held by the person 90 passing through the passage 92. The control unit 230 controls the output intensity of a radio wave from the commodity reading unit 101 based on the estimated quantity of the commodities.

In a case where the person 90 holds a large quantity of commodities, it becomes difficult to read commodity information due to overlapping of the commodities, for example.

Therefore, the control unit 230 increases the output intensity of a radio wave from the commodity reading unit 101 as the quantity of commodities held by the person 90 increases.

For example, in the example of FIG. 4, the person 90 passes through the passage 92 in a state where there are commodities in a basket 900. An image captured by the imaging unit 150 includes the basket 900 and the commodities in the basket 900. The recognition unit 240 recognizes the basket 900 in the image acquired by the imaging unit 150, and further estimates a quantity of the commodities in the basket 900. The recognition unit 240 outputs information indicating the estimated quantity of the commodities. The quantity of the commodities, which is estimated by the recognition unit 240, is a volume of the commodities, for example. The recognition unit 240 may output an index or a level indicating how much the quantity of commodities is as information indicating the quantity of the commodities.

However, the person 90 may directly hold commodities in a hand, instead of using the basket 900. In that case, the recognition unit 240 estimates the quantity of the commodities held by the person 90 in the hand. The person 90 may pass through the passage 92 in a state where commodities are put in a shopping bag. In that case, the recognition unit 240 estimates the quantity of the commodities in the shopping bag. The quantity of the commodities in the shopping bag may be estimated based on, for example, a size of the shopping bag or how much the shopping bag is expanded.

As the information indicating the quantity of the commodities is acquired from the recognition unit 240, the control unit 230 controls an output of a radio wave from the commodity reading unit 101 based on the quantity of the commodities, which the information indicates.

Specifically, the control unit 230 increases the output intensity of a radio wave at a timing at which the commodity reading unit 101 performs reading as the quantity of commodities increases. In the examples of FIGS. 4 and 5, for example, the control unit 230 increases the output intensities of all the antennas 121a to 121d as the quantity of commodities increases.

For example, first reference information (a table or a formula, for example) indicating a relationship between the quantity of commodities and the output intensity of a radio wave is held in advance in the storage unit that is accessible from the control unit 230. The control unit 230 designates the output intensity by using the first reference information and the quantity of commodities, which has been estimated by the recognition unit 240. The control unit 230 then controls and causes the commodity reading unit 101 to output a radio wave at the designated output intensity.

In a fourth example to a sixth example described below, the recognition unit 240 estimates, by processing an image, the state of the person 90 passing through the passage 92.

The control unit 230 then controls the output intensity of a radio wave from the commodity reading unit 101 based on the estimated state of the person 90.

### Fourth Example of Control

The recognition unit 240 estimates a method by which the person 90 passing through the passage 92 holds commodities as the state of the person 90 passing through the passage 92.

The control unit 230 controls the output intensity of a radio wave from the commodity reading unit 101 based on the method by which the person 90 holds the commodities.

Readability of commodity information varies depending on how the person 90 holds commodities. For example, in a case where the person 90 directly holds commodities in a hand (hereinafter also referred to as a “first method”), commodity information is difficult to be read due to an influence of reflection of a radio wave by the person 90. In a case where the person 90 holds commodities in a state of being in a shopping bag (hereinafter also referred to as a “second method”), commodity information is difficult to be read due to that the commodities are high in density. On the other hand, in a case where the person 90 holds commodities in a state of being in the basket 900 (hereinafter also referred to as a “third method”), commodity information is relatively easily read. Therefore, in a case where a method by which the person 90 holds commodities is the first method or the second method, the control unit 230 increases the output intensity of a radio wave from the commodity reading unit 101, compared with the case of the third method.

An image captured by the imaging unit 150 includes the person 90 passing through the passage 92. The recognition unit 240 recognizes the person 90 in the image acquired by the imaging unit 150, and further identifies (estimates) a method by which the person 90 holds the commodities. For example, the recognition unit 240 identifies whether the method by which the person 90 holds the commodities is any of the first method, the second method, and the third method described above. The recognition unit 240 then outputs information indicating the identified method. The information outputted by the recognition unit 240 may be information indicating any of the first method, the second method, and the third method.

As the information indicating the method by which the person 90 holds the commodities is acquired from the recognition unit 240, the control unit 230 controls the output intensity of a radio wave from the commodity reading unit 101 in a case where the commodity reading unit 101 performs reading based on the method indicated by the information. For example, the storage unit that is accessible from the control unit 230 holds in advance second reference information (a table, for example) indicating a relationship between a method by which person 90 holds commodities (for example, the first method, the second method, and the third method) and the output intensity of a radio wave. The control unit 230 uses the second reference information and the method by which the person 90 holds the commodities, which is estimated by the recognition unit 240, to designate the output intensity. In a case where the commodity reading unit 101 performs reading, the control unit 230 causes the commodity reading unit 101 to output a radio wave at the designated output intensity.

### Fifth Example of Control

The recognition unit 240 estimates a speed at which the person 90 moves as the state of the person 90 passing through the passage 92. The control unit 230 controls the output intensity of a radio wave from the commodity reading unit 101 based on the speed of the person 90.

Readability of commodity information varies depending on the speed of the person 90. As the person 90 passes through the passage 92 faster, commodity information held by the person 90 is difficult to be read. This is because a period of time during which reading is possible is short. Therefore, the control unit 230 increases the output intensity of a radio wave from the commodity reading unit 101 as the speed of the person 90 increases.

An image captured by the imaging unit 150 includes the person 90 passing through the passage 92. In the present example, the imaging unit 150 captures a plurality of images while the person 90 moves in the passage 92. The imaging unit 150 may capture a moving image of the person 90. The recognition unit 240 recognizes the person 90 in the images acquired by the imaging unit 150, uses results of the recognition in the plurality of images, and identifies the speed of the person 90. The recognition unit 240 then outputs information indicating the identified speed.

As the information indicating the speed of the person 90 is acquired from the recognition unit 240, the control unit 230 controls an output of a radio wave from the commodity reading unit 101 based on the speed that the information indicates. For example, third reference information (a table or a formula, for example) indicating a relationship between the speed of the person 90 and the output intensity of a radio wave is held in advance in the storage unit that is accessible from the control unit 230. The control unit 230 uses the third reference information and the speed of the person 90, which has been estimated by the recognition unit 240, to designate the output intensity. At a timing at which the commodity reading unit 101 performs reading, the control unit 230 causes the commodity reading unit 101 to output a radio wave at the designated output intensity.

### Sixth Example of Control

The recognition unit 240 estimates which side the person 90 passing through the passage 92 holds commodities as the state of the person 90 passing through the passage 92. The control unit 230 controls the output intensity of a radio wave from the commodity reading unit 101 based on which side the person 90 holds the commodities.

In the case that the antennas 121 are provided on both sides of the passage 92 as illustrated in FIG. 5, the antennas 121 that easily read commodity information differ depending on which side the person 90 holds commodities. For example, in a case where the person 90 holds commodities with the right hand, the commodity information is easily read by the antennas 121 on a side facing the right hand of the person 90. On the other hand, in a case where the person 90 holds commodities with the left hand, the commodity information is easily read by the antennas 121 on a side facing the left hand of the person 90. Therefore, in a case where the person 90 holds commodities with the right hand, the control unit 230 increases the output intensities of radio waves from the antennas 121 positioned on the right side in a traveling direction of the passage 92. In a case where the person 90 holds commodities with the left hand, the control unit 230 increases the output intensities of radio waves from the antennas 121 positioned on the left side in the traveling direction of the passage 92.

An image captured by the imaging unit 150 includes the person 90 passing through the passage 92. The recognition unit 240 recognizes the person 90 in the image acquired by the imaging unit 150, and further identifies (estimates) which side the person 90 holds the commodities. Specifically, the recognition unit 240 identifies whether the person 90 holds the commodities on the right side or the left side. A case where the person 90 holds the commodities on the right side includes a case where the person 90 holds the basket 900 or a shopping bag containing the commodities on the right side. A case where the person 90 holds the commodities on the left side includes a case where the person 90 holds the basket 900 or a shopping bag containing the commodities on the left side. The recognition unit 240 then outputs information indicating which side the person 90 holds the commodities.

The control unit 230 acquires, from the recognition unit 240, information indicating which side the person 90 holds the commodities. The control unit 230 controls the output intensities of radio waves from the plurality of antennas 121 at a timing at which the commodity reading unit 101 performs reading based on whether the information acquired from the recognition unit 240 indicates “left side” or “right side”. For example, in a case where the information indicating “right side” has been acquired, the control unit 230 sets the output intensities of radio waves from one or more of the antennas 121, which is or are positioned on the right side of the passage 92, higher than the output intensities of radio waves from one or more of the antennas 121, which is or are positioned on the left side of the passage 92. For example, in a case where the information indicating “left side” has been acquired, the control unit 230 sets the output intensities of radio waves from one or more of the antennas 121, which is or are positioned on the left side of the passage 92, higher than the output intensities of radio waves from one or more of the antennas 121, which is or are positioned on the right side of the passage 92.

The third example to the sixth example of the method in which the control unit 230 controls the reading condition of the commodity reading unit 101 have been described above. However, the method in which the control unit 230 controls the reading condition of the commodity reading unit 101 is not limited to these examples.

Next, working and effects of the present modification will be described. In the present modification, it is possible to acquire working and effects, which are similar to those of the first example embodiment.

### Second Example Embodiment

The reading device 10 according to the second example embodiment is identical to the reading device 10 according to at least either the first example embodiment or the modification except for those points described below.

In the present example embodiment, an example in which the control unit 230 controls the identification unit 250 based on a result of recognition of the recognition unit 240 will be described. More specifically, the control unit 230 controls processing for the identification unit 250 to identify commodity information of target commodities based on the result of the recognition of the recognition unit 240.

However, processing of the recognition unit 240 and the control unit 230 exemplified below may be solely performed, or may be performed together with the processing described in at least either the first example embodiment or the modification.

The recognition unit 240 detects, by processing an image, the person 91 who is not passing through the passage 92. The recognition unit 240 estimates an attribute of the detected person 91. The control unit 230 then controls, by using the estimated attribute, the identification unit 250 to identify the commodity held by the person 90 who has passed through the passage 92.

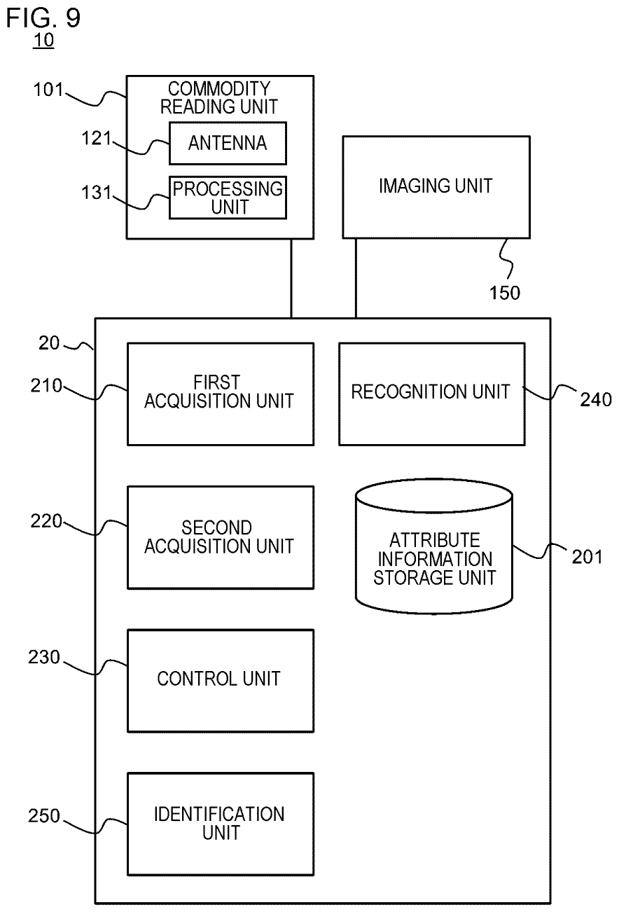

FIG. 9 is a diagram exemplifying a functional configuration of the reading device 10 according to the present example embodiment. In the present example embodiment, the information processing device 20 further includes an attribute information storage unit 201.

However, the attribute information storage unit 201 may be provided outside the information processing device 20 or may be provided outside the reading device 10. In a case where the attribute information storage unit 201 is provided inside the information processing device 20, for example, the attribute information storage unit 201 is achieved by using the storage device 1080 of the computer 1000 that achieves the information processing device 20.

In the attribute information storage unit 201, a plurality of pieces of attribute information are held in advance in a state of being associated with one or more pieces of commodity information. The attribute information indicates, for example, one of or a combination of one or more of gender, generation class, height, and weight. Each piece of attribute information is then associated with commodity information of commodities that are highly likely to be purchased by a person with the attribute indicated by the attribute information. It is possible to associate attribute information with one or more pieces of commodity information based on a questionnaire survey in advance, a characteristic of a commodity, and a sales record, for example. Identical commodity information may be associated with a plurality of pieces of attribute information.

As described in the first example embodiment, the recognition unit 240 according to the present example embodiment analyzes an image acquired by the imaging unit 150 to detect the person 90 passing through the passage 92. As the person 90 passing through the passage 92 is detected, the recognition unit 240 according to the present example embodiment estimates an attribute of the person 90.

The recognition unit 240 according to the present example embodiment detects the person 91 who is not passing through the passage 92, similar to the second example of control described in the first example embodiment. As the person 91 who is not passing through the passage 92 is detected, the recognition unit 240 estimates an attribute of the person 91. In a case where the recognition unit 240 detects the person 91 who is not passing through the passage 92, the control unit 230 causes the identification unit 250 to identify target commodities based on the attribute of the person 91. For example, the control unit 230 causes the identification unit 250 to identify target commodities as described below.

The identification unit 250 identifies one or more pieces of commodity information associated with attribute information relevant to the attribute of the person 91 as a “first commodity information group” in the attribute information storage unit 201. The identification unit 250 identifies one or more pieces of commodity information associated with attribute information relevant to the attribute of the person 90 as a “second commodity information group” in the attribute information storage unit 201.

Similar to the first example embodiment, the first acquisition unit 210 of the information processing device 20 acquires, from the commodity reading unit 101, results of reading of the commodity reading unit 101, which are acquired at a timing at which the person 90 passes through the passage 92.

The identification unit 250 identifies target commodities by using the results of the reading of the commodity reading unit 101, the first commodity information group, and the second commodity information group. Specifically, the identification unit 250 identifies commodity information that is included in the first commodity information group, but is not included in the second commodity information group, among one or more pieces of commodity information included in the results of the reading, which are acquired by the first acquisition unit 210. The identification unit 250 then identifies one or more pieces of commodity information of target commodities by removing the identified commodity information from the one or more pieces of commodity information included in the results of the reading.

In this manner, the identification unit 250 excludes commodity information determined using the attribute information of the person 91 from results of reading. As a result, it is possible to exclude commodity information that is highly likely to be noise from the result of the reading.

In the present example embodiment, it is preferable that the control unit 230 controls the identification unit 250 based on a result of recognition for an image captured at a timing at which the person 90 is present in the passage 92.

Next, working and effects of the present example embodiment will be described. In the present example embodiment, it is possible to acquire working and effects, which are similar to those of the first example embodiment. According to the present example embodiment, the control unit 230 controls the identification unit 250 to identify commodities held by the person 90 who has passed through the passage 92 by using the estimated attribute of the person 91 who is not passing through the passage 92. Therefore, it is possible to identify with high accuracy commodities held by the person 90 who has passed through the passage 92.

### Third Example Embodiment

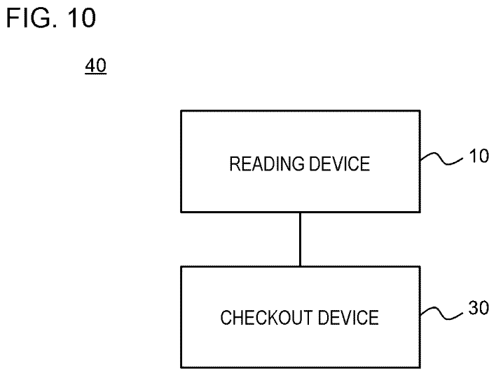

FIG. 10 is a diagram illustrating an outline of a checkout system 40 according to a third example embodiment. The checkout system 40 according to the present example embodiment includes the reading device 10 and a checkout device 30. The checkout device 30 performs checkout processing of a target commodity. The target commodity is a commodity identified, as the commodity held by the person 90 who has passed through the passage 92, by the identification unit 250 of the reading device 10. The reading device 10 is identical to the reading device 10 according to at least one of the first and second example embodiments and the modification.

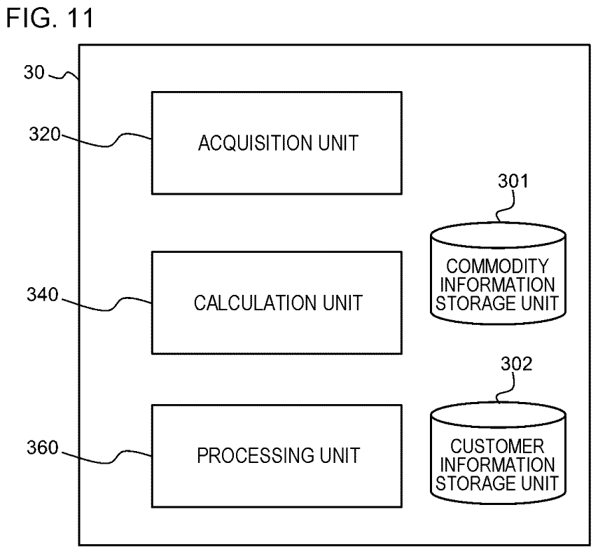

FIG. 11 is a diagram exemplifying a functional configuration of the checkout device 30 according to the present example embodiment. In the example of FIG. 11, the checkout device 30 includes an acquisition unit 320, a calculation unit 340, a processing unit 360, a commodity information storage unit 301, and a customer information storage unit 302. However, each of the commodity information storage unit 301 and the customer information storage unit 302 may be provided outside the checkout device 30.

In the commodity information storage unit 301, pieces of commodity information and prices of commodities are stored in advance in a state of being associated with each other, respectively. The acquisition unit 320 of the checkout device 30 acquires commodity information of one or more target commodities identified by the identification unit 250 from the identification unit 250 of the reading device 10. For each person 90 who has passed through the passage 92, the calculation unit 340 calculates a total price of all commodities held by the person 90. Specifically, the calculation unit 340 accesses the commodity information storage unit 301, identifies the price of each of target commodities, and calculates an amount of money that the person 90 should pay based on a result of adding all the prices of the target commodities.

The processing unit 360 then performs checkout processing using the amount of money that the calculation unit 340 has identified and payment information of the person 90, which is identified with a method described below.

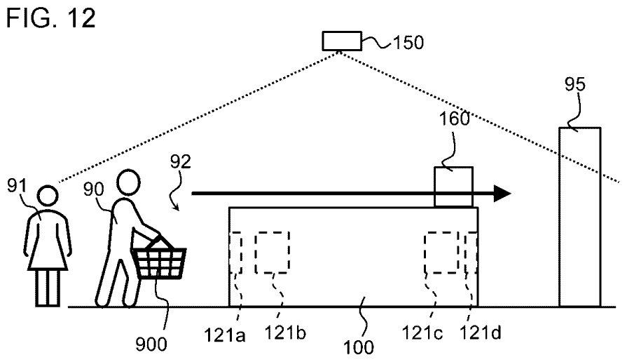

FIG. 12 is a diagram exemplifying a use environment of the reading device 10 according to the present example embodiment. FIG. 12 illustrates a state in which the passage 92 through which the person 90 who is about to purchase commodities passes is viewed from one side. The reading device 10 according to the present example embodiment is provided with a reading unit 160. The reading unit 160 reads information for identifying the person 90 or payment information for allowing the person 90 to make a payment. The reading unit 160 and the checkout device 30 are communicably connected to each other. An example of a method of identifying the payment information of the person 90 will be described below.

### First Example of Identifying Payment Information

In an example of the reading unit 160, imaging of the person 90 is performed. The reading unit 160 performs imaging of, for example, a face, a fingerprint, or an iris of the person 90. That is, the reading unit 160 performs imaging of the person 90 to acquire information for identifying the person 90. Performing authentication using the information for identifying the person 90 then makes it possible to allow the checkout device 30 to identify who the person 90 is. In the present example, the imaging unit 150 may also serve as the reading unit 160.

The reading unit 160 is not particularly limited in position with respect to the housings 100 and the passage 92. However, the reading unit 160 may perform imaging of the person 90 passing through, the person 90 immediately before passing through, or the person 90 immediately after passing through the passage 92. As a result, one or more target commodities that the identification unit 250 has identified and information that the reading unit 160 has read are associated with each other.

The person 90 registers in advance information necessary for authentication such as a photograph of the face of the person and payment information (for example, credit card information) used for payment. The registered information is stored in the customer information storage unit 302 in a state of being associated with, for example, identification information (for example, a member ID) of the person 90. As information for identifying the person 90 is acquired from the reading unit 160, the acquisition unit 320 of the checkout device 30 collates the information with the information necessary for authentication, which is stored in the customer information storage unit 302, and identifies the identification information and the payment information of the person 90 who has passed through the passage 92.

In this example, the person 90 is able to make a payment of held commodities only by passing through the passage 92 without being stopped.

### Second Example of Identifying Payment Information

An example of the reading unit 160 is a reader that reads a member ID of the person 90. For example, the reading unit 160 is an integrated circuit (IC) reader, a barcode reader, or a two-dimensional code reader that reads the member ID from a membership card held by the person 90. The membership card incorporates an IC chip storing the membership ID or a wireless communication tag. A barcode or a two-dimensional code indicating the membership ID is otherwise printed on the membership card. Although the position of the reading unit 160 with respect to the housings 100 and the passage 92 is not particularly limited, the reading unit 160 is provided, for example, at the entrance, the exit, or a middle position of the passage 92. The person 90 causes the reading unit 160 to read the member ID by holding the membership card over the reading unit 160 before, after, or while passing through the passage 92.

The person 90 registers his/her payment information (for example, credit card information) in advance. The registered payment information is stored in the customer information storage unit 302 in a state of being associated with, for example, the member ID of the person 90. As the member ID of the person 90 is acquired from the reading unit 160, the acquisition unit 320 of the checkout device 30 accesses the customer information storage unit 302 and identifies the payment information associated with the member ID as the payment

### Third Example of Identifying Payment Information

An example of the reading unit 160 is a reader that reads the payment information of the person 90. For example, the reading unit 160 is a reader that reads the payment information from a portable terminal or a card, for example, held by the person 90. Causing the reading unit 160 to read the payment information from a portable terminal or a card, for example, allows the person 90 to instantly perform an electronic payment with electronic money or a credit card. In this example, the customer information storage unit 302 may not be provided.

In this example, the reading unit 160 is provided near the exit of the passage 92. The reading unit 160 is provided at a position where the person 90 reaches after passing through the reading regions 111 of the commodity reading unit 101 included in the reading device 10.

As the payment information is acquired from the reading unit 160, the acquisition unit 320 of the checkout device 30 identifies the information as the payment information of the person 90 who has passed through the passage 92.

A hardware configuration of a computer that achieves functional components (the acquisition unit 320, the calculation unit 340, and the processing unit 360) of the checkout device 30 are represented as illustrated in FIG. 7, for example, similar to the information processing device 20. However, the storage device 1080 of the computer 1000 that achieves the checkout device 30 according to the present example embodiment stores program modules that achieve functions of the functional components of the checkout device 30 according to the present example embodiment.

In a case where the commodity information storage unit 301 and the customer information storage unit 302 are each provided inside the checkout device 30, for example, the commodity information storage unit 301 and the customer information storage unit 302 are each achieved by using the storage device 1080.

The checkout device 30 is communicable with the reading unit 160 and the information processing device 20 via the input/output interface 1100 or the network interface 1120 of the computer 1000 that achieves the checkout device 30. The information processing device 20 of the reading device 10 is communicable with the checkout device 30 via the input/output interface 1100 or the network interface 1120 of the computer 1000 that achieves the information processing device 20.

In a checkout method according to the present example embodiment, one or more computers perform checkout processing of s target commodity. The target commodity is a commodity identified, as the commodity held by the person 90 who has passed through the passage 92, by the identification unit 250 included in the reading device 10.

Next, working and effects of the present example embodiment will be described. Even in the present example embodiment, it is possible to acquire working and effects, which are similar to those of the first example embodiment. According to the present example embodiment, the checkout device 30 performs checkout processing of target commodities identified, as commodities held by the person 90 who has passed through the passage 92, by the identification unit 250 of the reading device 10. Therefore, the person 90 passing through the passage 92 is able to cause held commodities to be identified for smooth checkout processing.

Although the example embodiments of the present invention have been described above with reference to the drawings, these are examples of the present invention, and various configurations other than the above can be adopted.

In addition, in the plurality of flowcharts used in the above description, a plurality of steps (processing) are described in order, but the execution order of the steps executed in each example embodiment is not limited to the described order. In each example embodiment, the order of the illustrated steps can be changed as long as there is no problem in terms of content.

Furthermore, the example embodiments described above can be combined within a range in which the contents are not contradictory.

Some or all of the example embodiments described above may be described as the following Supplementary Notes, but are not limited to the following.
1-1. A reading apparatus including:
   a commodity reading means provided in a passage through which a person who is about to purchase commodities passes for reading commodity information from wireless communication tags attached to the commodities;
   an imaging means for capturing an image including at least either a reading region of the commodity reading means or a peripheral area of the reading region;
   an identification means for identifying, by using results of the reading of the commodity reading means, commodities held by the person who has passed through the passage; and
   a control means for controlling at least either a reading condition of the commodity reading means or the identification means based on a result of processing of the image.
1-2. The reading apparatus according to 1-1, in which
   the reading condition of the commodity reading means is at least one of an output intensity of a radio wave from the commodity reading means, an output direction of the radio wave from the commodity reading means, and a reading threshold for a reception intensity of the commodity reading means.
1-3. The reading apparatus according to 1-1 or 1-2, further including
   a recognition means for recognizing, by processing the image, a state of at least either a peripheral area of the passage or an interior of the passage,
   in which the control means controls at least either the reading condition of the commodity reading means or the identification means based on a result of the recognition of the recognition means.
1-4. The reading apparatus according to 1-3, in which
   the recognition means detects, by processing the image, at least either a store fixture positioned in the peripheral area of the passage or a person who is not passing through the passage.
1-5. The reading apparatus according to 1-4, in which
   the recognition means identifies, by processing the image, a position of the store fixture positioned in the peripheral area of the passage, and
   the control means lowers the output intensity of a radio wave from the commodity reading means at least in a direction in which the store fixture is present.
1-6. The reading apparatus according to 1-4, in which
   the recognition means
   detects, by processing the image, a person who is not passing through the passage, and
   estimates an attribute of the detected person, and
   the control means controls, by using the estimated attribute, the identification means to identify the commodity held by the person who has passed through the passage.
1-7. The reading apparatus according to 1-4, in which
   the recognition means detects, by processing the image, a person who is not passing through the passage, and
   the control means lowers, in a case where a person who is not passing through the passage is detected, the output intensity of a radio wave from the commodity reading means at least in a direction in which the person is present.
1-8. The reading apparatus according to 1-3, in which
   the recognition means estimates, by processing the image, a quantity of commodities held by the person passing through the passage, and
   the control means controls the output intensity of a radio wave from the commodity reading means based on the estimated quantity of the commodities.
1-9. The reading apparatus according to 1-3, in which
   the recognition means estimates, by processing the image, a state of the person passing through the passage, and
   the control means controls the output intensity of a radio wave from the commodity reading means based on the estimated state.
2-1. An information processing apparatus including:
   a first acquisition means for acquiring results of reading, the reading being performed by a commodity reading means provided in a passage through which a person who is about to purchase commodities passes for reading commodity information from wireless communication tags attached to the commodities;
   a second acquisition means for acquiring an image including at least either a reading region of the commodity reading means or a peripheral area of the reading region;
   an identification means for identifying, by using the results of the reading of the commodity reading means, commodities held by the person who has passed through the passage; and
   a control means for controlling at least either a reading condition of the commodity reading means or the identification means based on a result of processing of the image.
2-2. The information processing apparatus according to 2-1, in which
   the reading condition of the commodity reading means is at least one of an output intensity of a radio wave from the commodity reading means, an output direction of the radio wave from the commodity reading means, and a reading threshold for a reception intensity of the commodity reading means.
2-3. The information processing apparatus according to 2-1 or 2-2,
   further including a recognition means for recognizing, by processing the image, a state of at least either a peripheral area of the passage or an interior of the passage,
   in which the control means controls at least either the reading condition of the commodity reading means or the identification means based on a result of the recognition of the recognition means.
2-4. The information processing apparatus according to 2-3, in which
   the recognition means detects, by processing the image, at least either a store fixture positioned in the peripheral area of the passage or a person who is not passing through the passage.
2-5. The information processing apparatus according to 2-4, in which
   the recognition means identifies, by processing the image, a position of the store fixture positioned in the peripheral area of the passage, and
   the control means lowers the output intensity of a radio wave from the commodity reading means at least in a direction in which the store fixture is present.
2-6. The information processing apparatus according to 2-4, in which
   the recognition means
   detects, by processing the image, a person who is not passing through the passage, and estimates an attribute of the detected person, and
   the control means controls, by using the estimated attribute, the identification means to identify the commodity held by the person who has passed through the passage.
2-7. The information processing apparatus according to 2-4, in which
   the recognition means detects, by processing the image, a person who is not passing through the passage, and
   the control means lowers, in a case where a person who is not passing through the passage is detected, the output intensity of a radio wave from the commodity reading means at least in a direction in which the person is present.
2-8. The information processing apparatus according to 2-3, in which
   the recognition means estimates, by processing the image, a quantity of commodities held by the person passing through the passage, and
   the control means controls the output intensity of a radio wave from the commodity reading means based on the estimated quantity of the commodities.
2-9. The information processing apparatus according to 2-3, in which
   the recognition means estimates by processing the image, a state of the person passing through the passage, and
   the control means controls the output intensity of a radio wave from the commodity reading means based on the estimated state.
3-1. A checkout system including:
   the reading apparatus according to any one of 1-1 to 1-9; and
   a checkout apparatus that performs checkout processing of target commodities identified by the identification means as commodities held by the person who has passed through the passage.
4-1. A reading method including:
   reading, with a commodity reading means provided in a passage through which a person who is about to purchase commodities passes, commodity information from wireless communication tags attached to the commodities;
   capturing an image including at least either a reading region of the commodity reading means or a peripheral area of the reading region;
   identifying, by using results of the reading of the commodity reading means, commodities held by the person who has passed through the passage; and
   controlling at least either a reading condition of the commodity reading means or an identification method of the commodities held by the person who has passed through the passage based on a result of processing of the image.
4-2. The reading method according to 4-1, in which
   the reading condition of the commodity reading means is at least one of an output intensity of a radio wave from the commodity reading means, an output direction of the radio wave from the commodity reading means, and a reading threshold for a reception intensity of the commodity reading means.
4-3. The reading method according to 4-1 or 4-2,
   further including recognizing, by processing the image, a state of at least either a peripheral area of the passage or an interior of the passage,
   in which the controlling includes controlling at least either the reading condition of the commodity reading means or the identification method based on a result of the recognition.
4-4. The reading method according to 4-3, in which
the recognizing includes detecting, by processing the image, at least either a store fixture positioned in the peripheral area of the passage or a person who is not passing through the passage.
4-5. The reading method according to 4-4, in which
   the recognizing includes identifying, by processing the image, a position of the store fixture positioned in the peripheral area of the passage, and
   the controlling includes lowering the output intensity of a radio wave from the commodity reading means at least in a direction in which the store fixture is present.
4-6. The reading method according to 4-4, in which
   the recognizing includes
   detecting, by processing the image, a person who is not passing through the passage, and
   estimating an attribute of the detected person; and
   the controlling includes controlling, by using the estimated attribute, the identification method to identify the commodity held by the person who has passed through the passage.
4-7. The reading method according to 4-4, in which
   the recognizing includes detecting, by processing the image, a person who is not passing through the passage, and
   the controlling includes lowering, in a case where a person who is not passing through the passage is detected, the output intensity of a radio wave from the commodity reading means at least in a direction in which the person is present.
4-8. The reading method according to 4-3, in which
   the recognizing includes estimating, by processing the image, a quantity of commodities held by the person passing through the passage, and
   the controlling includes controlling the output intensity of a radio wave from the commodity reading means based on the estimated quantity of the commodities.
4-9. The reading method according to 4-3, in which
   the recognizing includes estimating, by processing the image, a state of the person passing through the passage, and
   the controlling includes controlling the output intensity of a radio wave from the commodity reading means based on the estimated state.
5-1. An information processing method including causing one or more computers to:
   acquire results of reading, the reading being performed by a commodity reading means provided in a passage through which a person who is about to purchase commodities passes for reading commodity information from wireless communication tags attached to the commodities;
   acquire an image including at least either a reading region of the commodity reading means or a peripheral area of the reading region;
   identify, by using the results of the reading of the commodity reading means, commodities held by the person who has passed through the passage; and
   control at least either a reading condition of the commodity reading means or an identification method of the commodities held by the person who has passed through the passage based on a result of processing of the image.
5-2. The information processing method according to 5-1, in which
   the reading condition of the commodity reading means is at least one of an output intensity of a radio wave from the commodity reading means, an output direction of the radio wave from the commodity reading means, and a reading threshold for a reception intensity of the commodity reading means.
5-3. The information processing method according to 5-1 or 5-2,
   in which the one or more computers further recognize, by processing the image, a state of at least either a peripheral area of the passage or an interior of the passage, and
   the one or more computers control at least either the reading condition of the commodity reading means or the identification method based on a result of the recognition of the recognition means.
5-4. The information processing method according to 5-3, in which
   the one or more computers detect, by processing the image, at least either a store fixture positioned in the peripheral area of the passage or a person who is not passing through the passage.
5-5. The information processing method according to 5-4, in which
   the one or more computers
   identify, by processing the image, a position of the store fixture positioned in the peripheral area of the passage, and
   lower the output intensity of a radio wave from the commodity reading means at least in a direction in which the store fixture is present.
5-6. The information processing method according to 5-4, in which
   the one or more computers
   detect, by processing the image, a person who is not passing through the passage,
   estimate an attribute of the detected person, and
   control, by using the estimated attribute, the identification method to identify the commodity held by the person who has passed through the passage.
5-7. The information processing method according to 5-4, in which
   the one or more computers
   detect, by processing the image, a person who is not passing through the passage, and
   lower, in a case where a person who is not passing through the passage is detected, the output intensity of a radio wave from the commodity reading means at least in a direction in which the person is present.
5-8. The information processing method according to 5-3, in which
   the one or more computers
   estimate, by processing the image, a quantity of commodities held by the person passing through the passage, and
   control the output intensity of a radio wave from the commodity reading means based on the estimated quantity of the commodities.
5-9. The information processing method according to 5-3, in which
   the one or more computers
   estimate, by processing the image, a state of the person passing through the passage, and
   control the output intensity of a radio wave from the commodity reading means based on the estimated state.
6-1. A checkout method including
   causing one or more computers
   to perform checkout processing of target commodities identified by the identification means included in the reading apparatus according to any one of 1-1 to 1-9 as commodities held by the person who has passed through the passage.
7-1. A program causing a computer to function as:
   a first acquisition means for acquiring results of reading, the reading being performed by a commodity reading means provided in a passage through which a person who is about to purchase commodities passes for reading commodity information from wireless communication tags attached to the commodities;
   a second acquisition means for acquiring an image including at least either a reading region of the commodity reading means or a peripheral area of the reading region;
   an identification means for identifying, by using the results of the reading of the commodity reading means, commodities held by the person who has passed through the passage; and
   a control means for controlling at least either a reading condition of the commodity reading means or the identification means based on a result of processing of the image.
7-2. The program according to 7-1, in which
   the reading condition of the commodity reading means is at least one of an output intensity of a radio wave from the commodity reading means, an output direction of the radio wave from the commodity reading means, and a reading threshold for a reception intensity of the commodity reading means.
7-3. The program according to 7-1 or 7-2, in which
   the computer is further caused to function as a recognition means for recognizing, by processing the image, a state of at least either a peripheral area of the passage or an interior of the passage, and
   the control means controls at least either the reading condition of the commodity reading means or the identification means based on a result of the recognition of the recognition means.
7-4. The program according to 7-3, in which
   the recognition means detects, by processing the image, at least either a store fixture positioned in the peripheral area of the passage or a person who is not passing through the passage.
7-5. The program according to 7-4, in which
   the recognition means identifies, by processing the image, a position of the store fixture positioned in the peripheral area of the passage, and
   the control means lowers the output intensity of a radio wave from the commodity reading means at least in a direction in which the store fixture is present.
7-6. The program according to 7-4, in which
   the recognition means
   detects, by processing the image, a person who is not passing through the passage, and
   estimates an attribute of the detected person, and
   the control means controls, by using the estimated attribute, the identification means to identify the commodity held by the person who has passed through the passage.
7-7. The program according to 7-4, in which
   the recognition means detects, by processing the image, a person who is not passing through the passage, and
   the control means lowers, in a case where a person who is not passing through the passage is detected, the output intensity of a radio wave from the commodity reading means at least in a direction in which the person is present.
7-8. The program according to 7-3, in which
   the recognition means estimates, by processing the image, a quantity of commodities held by the person passing through the passage, and the control means controls the output intensity of a radio wave from the commodity reading means based on the estimated quantity of the commodities.
7-9. The program according to 7-3, in which
   the recognition means estimates, by processing the image, a state of the person passing through the passage, and
   the control means controls the output intensity of a radio wave from the commodity reading means based on the estimated state.
8-1. A computer-readable medium on which the program according to any one of 7-1 to 7-9 is recorded.

### REFERENCE SIGNS LIST

10 reading device
20 information processing device
95 store fixture
100 housing
101 commodity reading unit
111 reading region
121 antenna
131 processing unit
150 imaging unit
160 reading unit
201 attribute information storage unit
210 first acquisition unit
220 second acquisition unit
230 control unit
240 recognition unit
250 identification unit
301 commodity information storage unit
302 customer information storage unit
320 acquisition unit
340 calculation unit
360 processing unit
1000 computer

What is claimed is:

1. A reading apparatus comprising:
a commodity reader provided in a passage through which a person who is about to purchase a commodity passes for reading commodity information from a wireless communication tag attached to the commodity;
a camera for capturing an image including at least either a reading region of the commodity reader or a peripheral area of the reading region;
at least one memory storing instructions; and
at least one processor configured to execute the instructions to perform operations comprising:
identifying, by using results of the reading by the commodity reader, a commodity held by the person who has passed through the passage; and
controlling at least either a reading condition of the commodity reader or an identification method of the commodities held by the person who has passed through the passage based on a result of processing of the image.

2. The reading apparatus according to claim 1, wherein
the reading condition of the commodity reader is at least one of an output intensity of a radio wave from the commodity reader an output direction of the radio wave from the commodity reader, and a reading threshold for a reception intensity of the commodity reader.

3. The reading apparatus according to claim 1, wherein
the operations further comprise recognizing, by processing the image, a state of at least either a peripheral area of the passage or an interior of the passage, and
controlling at least either the reading condition of the commodity reader or the identification method comprises controlling at least either the reading condition of the commodity reader or the identification method based on a result by recognizing the state.

4. The reading apparatus according to claim 3, wherein
recognizing the state comprises detecting, by processing the image, at least either a store fixture positioned in the peripheral area of the passage or a person who is not passing through the passage.

5. The reading apparatus according to claim 4, wherein
recognizing the state further comprises identifying, by processing the image, a position of the store fixture positioned in the peripheral area of the passage, and
controlling at least either the reading condition of the commodity reader or the identification method comprise lowering the output intensity of a radio wave from the commodity reader at least in a direction in which the store fixture is present.

6. The reading apparatus according to claim 4, wherein
recognizing the state further comprises:
detecting, by processing the image, a person who is not passing through the passage; and
estimating an attribute of the detected person, and
controlling at least either the reading condition of the commodity reader or the identification method comprise controlling, by using the estimated attribute, the identification method to identify the commodity held by the person who has passed through the passage.

7. The reading apparatus according to claim 4, wherein
recognizing the state further comprises detecting by processing the image, a person who is not passing through the passage, and
controlling at least either the reading condition of the commodity reader or the identification method comprise lowering, in a case where a person who is not passing through the passage is detected, the output intensity of a radio wave from the commodity reader at least in a direction in which the person who is not passing through the passage is present.

8. The reading apparatus according to claim 3, wherein
recognizing the state comprises estimating, by processing the image, a quantity of commodities held by the person passing through the passage, and
controlling at least either the reading condition of the commodity reader or the identification method further comprises controlling the output intensity of a radio wave from the commodity reader based on the estimated quantity of the commodities.

9. The reading apparatus according to claim 3, wherein
recognizing the state comprises estimating, by processing the image, a state of the person passing through the passage, and
controlling at least either the reading condition of the commodity reader or the identification method further comprises controlling the output intensity of a radio wave from the commodity reader based on the estimated state.

10. (canceled)

11. A checkout system comprising:
a reading apparatus; and
a checkout apparatus that performs checkout processing of a target commodity, wherein
the reading apparatus comprises:
a commodity reader provided in a passage through which a person who is about to purchase a commodity passes for reading commodity information from a wireless communication tag attached to the commodity;
a camera for capturing an image including at least either a reading region of the commodity reader or a peripheral area of the reading region;
at least one memory storing instructions; and
at least one processor configured to execute the instructions to perform operations comprising:
identifying, by using results of the reading by the commodity reader, a commodity held by the person who has passed through the passage; and
controlling at least either a reading condition of the commodity reader or an identification method of the commodities held by the person who has passed through the passage based on a result of processing of the image, and
the target commodity is a commodity identified by the reading apparatus as the commodity held by the person who has passed through the passage.

12. A reading method comprising:
reading, with a commodity reader provided in a passage through which a person who is about to purchase a commodity passes, commodity information from a wireless communication tag attached to the commodity;
capturing an image including at least either a reading region of the commodity reader or a peripheral area of the reading region;
identifying, by using results of the reading by the commodity reader, a commodity held by the person who has passed through the passage; and
controlling at least either a reading condition of the commodity reader or an identification method of the commodity held by the person who has passed through the passage based on a result of processing of the image.

13-15. (canceled)

16. The checkout system according to claim 11, wherein
the operations further comprise recognizing, by processing the image, a state of at least either a peripheral area of the passage or an interior of the passage, and
controlling at least either the reading condition of the commodity reader or the identification method comprises controlling at least either the reading condition of the commodity reader or the identification method based on a result by recognizing the state.

17. The checkout system according to claim 16, wherein
recognizing the state comprises detecting, by processing the image, at least either a store fixture positioned in the peripheral area of the passage or a person who is not passing through the passage.

18. The checkout system according to claim 16, wherein
recognizing the state comprises estimating, by processing the image, a quantity of commodities held by the person passing through the passage, and
controlling at least either the reading condition of the commodity reader or the identification method further comprises controlling the output intensity of a radio wave from the commodity reader based on the estimated quantity of the commodities.

19. The checkout system according to claim 16, wherein
recognizing the state comprises estimating, by processing the image, a state of the person passing through the passage, and
controlling at least either the reading condition of the commodity reader or the identification method further comprises controlling the output intensity of a radio wave from the commodity reader based on the estimated state.

20. The reading method according to claim 12, further comprising
recognizing, by processing the image, a state of at least either a peripheral area of the passage or an interior of the passage, wherein
controlling at least either the reading condition of the commodity reader or the identification method comprises controlling at least either the reading condition of the commodity reader or the identification method based on a result by recognizing the state.

21. The reading method according to claim 20, wherein
recognizing the state comprises detecting, by processing the image, at least either a store fixture positioned in the peripheral area of the passage or a person who is not passing through the passage.

22. The reading method according to claim 20, wherein
recognizing the state comprises estimating, by processing the image, a quantity of commodities held by the person passing through the passage, and
controlling at least either the reading condition of the commodity reader or the identification method further comprises controlling the output intensity of a radio wave from the commodity reader based on the estimated quantity of the commodities.

23. The reading method according to claim 20, wherein
recognizing the state comprises estimating, by processing the image, a state of the person passing through the passage, and
controlling at least either the reading condition of the commodity reader or the identification method further comprises controlling the output intensity of a radio wave from the commodity reader based on the estimated state.
